(19) United States
(12) Patent Application Publication
(10) Pub. No.: US 2024/0282997 A1
(43) Pub. Date: Aug. 22, 2024

(54) MONOLITHIC SOLID OXIDE FUEL CELL APPARATUS AND METHOD

(71) Applicant: STACKED FUEL CELLS INC., Calgary (CA)

(72) Inventor: Evan Niels RASMUSSEN, Calgary (CA)

(21) Appl. No.: 18/570,303

(22) PCT Filed: Jun. 30, 2022
(86) PCT No.: PCT/CA2022/051052

§ 371 Date: Dec. 14, 2023

Related U.S. Application Data
(60) Provisional application No. 63/216,902, filed on Jun. 30, 2021.

(51) Int. Cl. H01M 8/2404; H01M 8/0202; H01M 8/12; H01M 8/2432; H01M 8/2483

(52) U.S. Cl. CPC H01M 8/2404; H01M 8/0202; H01M 8/2432; H01M 8/2483; H01M 2008/1293

(57) ABSTRACT

A fuel cell stack apparatus includes a fuel cell, having a first interconnect layer including an interconnect material, an anode layer including an anode material, an electrolyte layer including an electrolyte material, a cathode layer including a cathode material, and a second interconnect layer including the interconnect material; the electrolyte layer being positioned between the anode layer and the cathode layer, the electrolyte layer including an electrolyte material; and the anode layer, the electrolyte layer, and the cathode layer being positioned between the first interconnect layer and the second interconnect layer. A method for manufacturing a fuel cell stack includes depositing a first interconnect layer: depositing a first electrode layer; depositing an electrolyte layer; depositing a second electrode layer; depositing a second interconnect layer; and sintering at a first temperature.

### BENEFIT OF EARLIER APPLICATIONS

This application claims priority from U.S. provisional application 63/216,902, filed Jun. 30, 2021.

### TECHNICAL FIELD

The present invention relates to fuel cells in general, and solid-oxide fuel cell apparatus and methods of manufacture in particular.

### BACKGROUND

A fuel cell is a device that converts chemical fuels into electrical power. Fuel cells generally include four elements: an electrolyte, an interconnect, and two electrodes known as the cathode and anode. In monolithic designs, all four layers are sintered directly together without external support. In such a design, the interconnect has the dual purpose of containing the oxidant on the cathode side and fuel on the anode side of the cell, while allowing current to flow from the anode of one cell to the cathode of the next cell.

As described by U.S. Pat. No. 4,816,036, a fuel cell is a galvanic conversion device that chemically reacts hydrogen or a hydrocarbon fuel and an oxidant within catalytic confines to produce a DC electrical output. In a fuel cell, cathode material defines the passageways for the oxidant and anode material defines the passageways for the fuel, and an electrolyte separates the cathode and anode materials. The fuel and oxidant, typically as gases, are continuously passed through the cell passageways, separated from one another, and the fuel and oxidant discharge from the fuel cell generally remove the reaction products and heat generated in the cell. The fuel and oxidant are the working gases and as such are typically not considered an integral part of the fuel cell itself. In a solid electrolyte or solid oxide fuel cell, the electrolyte is in solid form in the fuel cell. In the solid oxide fuel cell, hydrogen or a high order hydrocarbon may be used as the fuel and oxygen or air may be used as the oxidant, and the operating temperature of the fuel cell may be between 600° and 1,100° C.

### SUMMARY OF INVENTION

In accordance with a broad aspect of the present invention, there is provided a fuel cell stack apparatus, comprising: a fuel cell, having a first interconnect layer including an interconnect material, an anode layer including an anode material, an electrolyte layer including an electrolyte material, a cathode layer including a cathode material, and a second interconnect layer including the interconnect material; the electrolyte layer being positioned between the anode layer and the cathode layer, the electrolyte layer including an electrolyte material; and the anode layer, the electrolyte layer, and the cathode layer being positioned between the first interconnect layer and the second interconnect layer.

In accordance with another broad aspect of the present invention, there is provided a method for manufacturing a fuel cell stack, comprising: depositing a first interconnect layer; depositing a first electrode layer; depositing an electrolyte layer; depositing a second electrode layer; depositing a second interconnect layer; and sintering at a first temperature.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

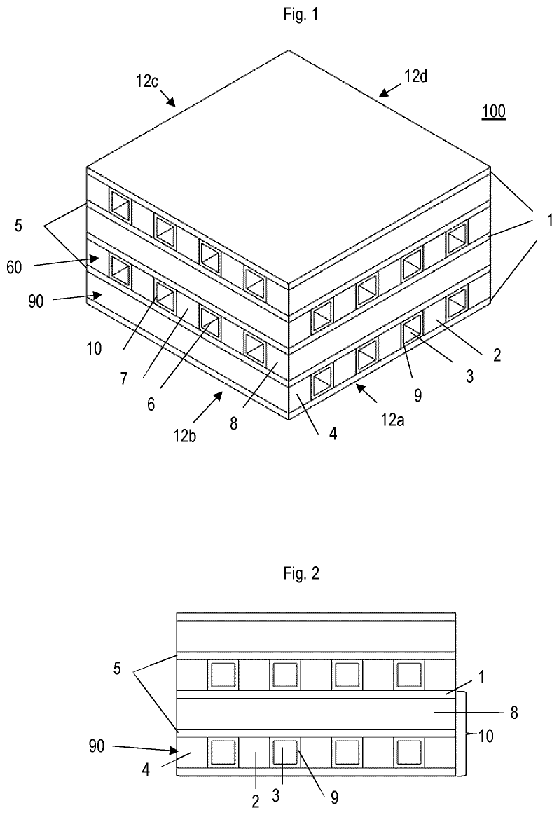

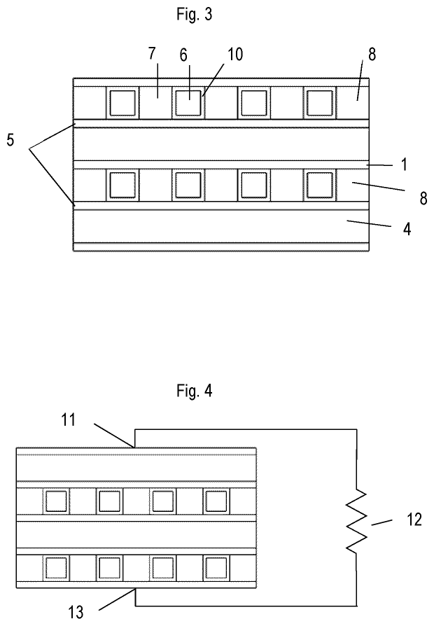

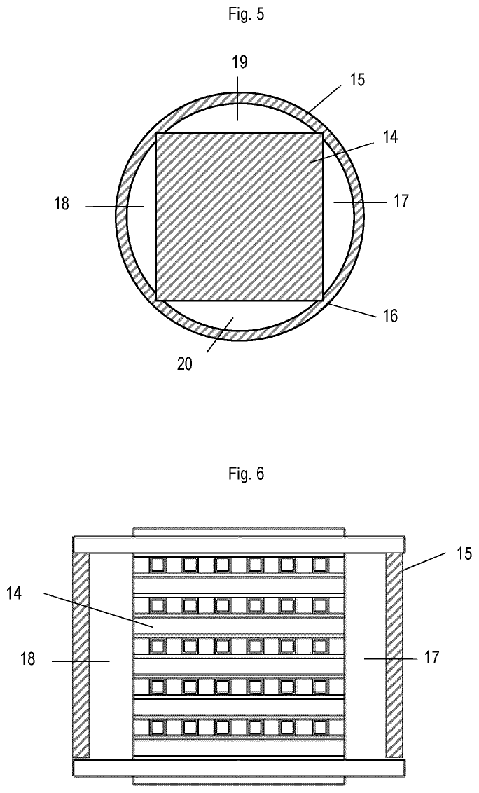

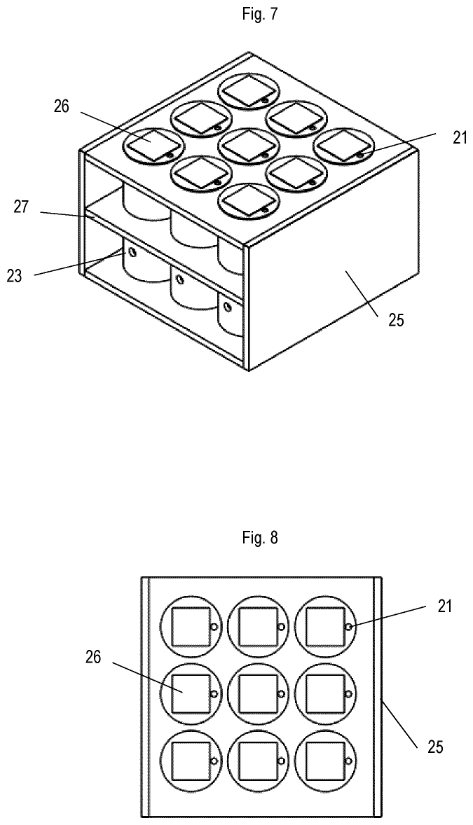

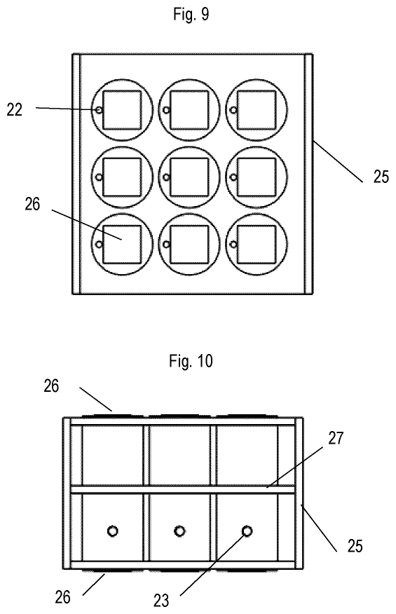

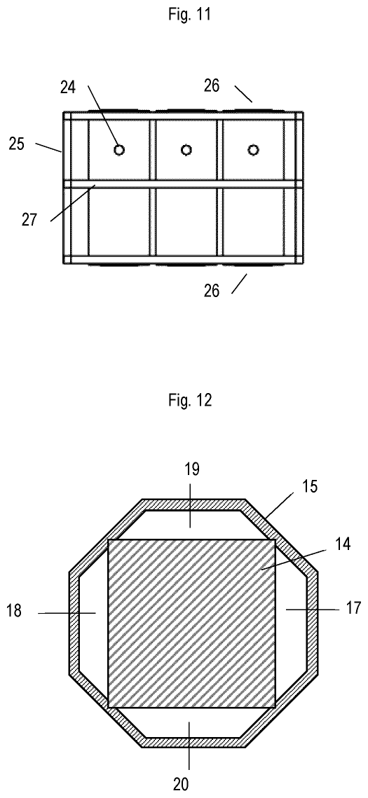

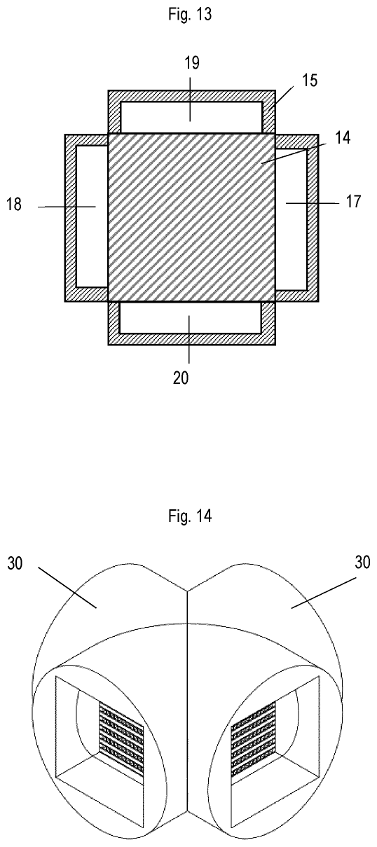

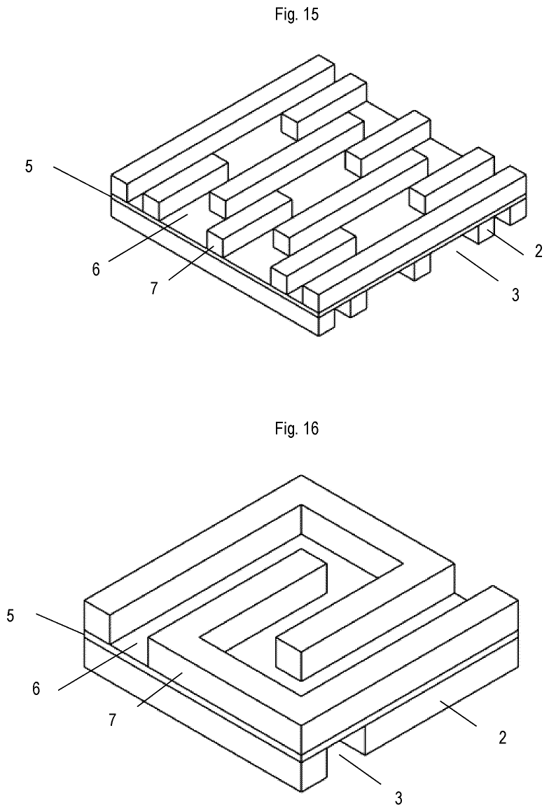

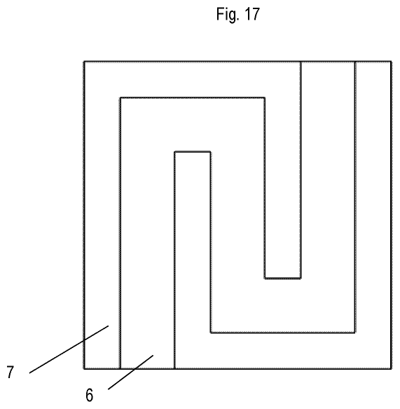

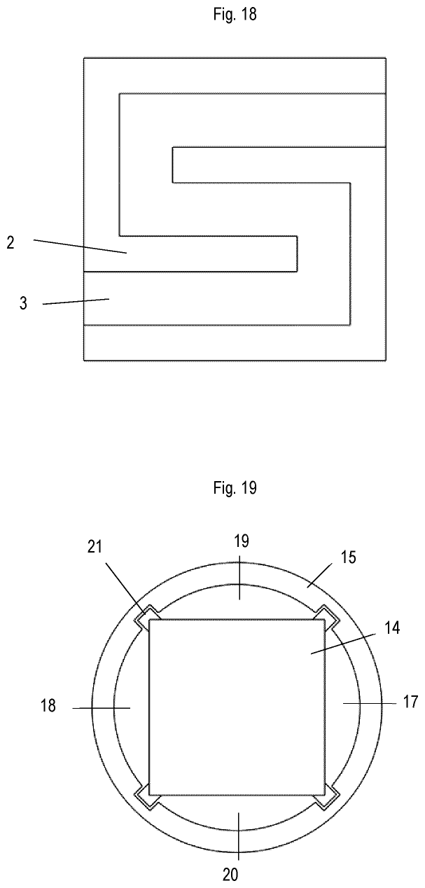

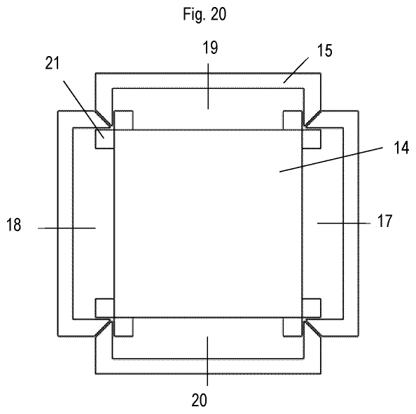

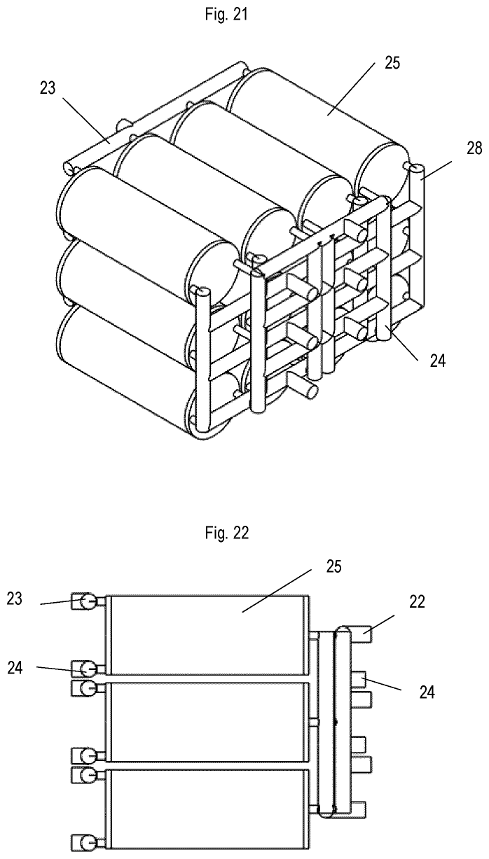

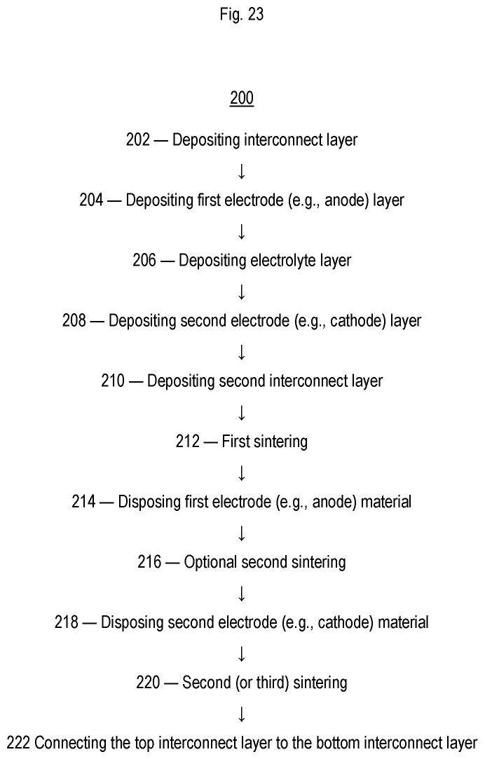

Referring to the drawings, several aspects of the present invention are illustrated by way of example, and not by way of limitation, in detail in the figures, wherein:
(a) FIG. 1 is an isometric view of a fuel cell stack according to one embodiment of the present invention;
(b) FIG. 2 is a side view of the fuel cell stack of FIG. 1;
(c) FIG. 3 is a top view of the fuel cell stack of FIG. 1;
(d) FIG. 4 is a wiring diagram showing a wire coupled to the fuel cell stack of FIG. 2 according to another embodiment of the present invention;
(e) FIG. 5 is a cross sectional view of a fuel cell stack with an outer tubular shell according to yet another embodiment of the present invention;
(f) FIG. 6 is a front cross sectional view of a fuel cell stack with an outer tubular shell according to yet another embodiment of the present invention;
(g) FIG. 7 is an isometric view of multiple fuel cell tubes in a shell and tube according to yet another embodiment of the present invention;
(h) FIG. 8 is a top view of the embodiment of FIG. 7;
(i) FIG. 9 is a bottom view of the embodiment of FIG. 7;
(j) FIG. 10 is a front view of the embodiment of FIG. 7;
(k) FIG. 11 is a back view of the embodiment of FIG. 7;
(l) FIG. 12 is a cross sectional view of a first alternative external sealing design according to yet another embodiment of the present invention;
(m) FIG. 13 is a cross sectional view of a second alternative external sealing design according to yet another embodiment of the present invention;
(n) FIG. 14 is an isometric view of a third alternative external sealing design according to yet another embodiment of the present invention;
(o) FIG. 15 is an isometric view of the first alternate flow channel configuration of FIG. 12 according to yet another embodiment of the present invention;
(p) FIG. 16 is an isometric view of the second alternate flow channel configuration of FIG. 13 according to yet another embodiment of the present invention;
(q) FIG. 17 is a top view of the embodiment of FIG. 16;
(r) FIG. 18 is a bottom view of the embodiment of FIG. 16;
(s) FIG. 19 is a top view of a fuel cell stack with an outer manifold with sealing flanges according to yet another embodiment of the present invention;
(t) FIG. 20 is a top view of a fuel cell stack with an alternate outer manifold with sealing flanges according to yet another embodiment of the present invention;
(u) FIG. 21 is an isometric view of multiple monolithic tubular stacks with a secondary manifold according to yet another embodiment of the present invention;
(v) FIG. 22 is a side view of the embodiment of FIG. 21; and
(w) FIG. 23 is a diagram illustrating a method of manufacturing a fuel cell stack according to yet another embodiment of the present invention.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In the prior art, generally, planar fuel cells are manufactured individually, and then the individual fuel cells are connected together to form a fuel cell stack. These are generally either anode- and/or electrolyte-supported fuel cells. In the case of an anode-supported cell, the cells are made by creating a relatively thick cermet layer of suitable anode material. This is most commonly nickel oxide and on the order of 400 microns thick.

A thin electrolyte layer is applied to a first side of the cell. The materials may then be sintered together. A thin layer of cathode material may then be applied to a second side of the cell, opposite the first side, and the cell may be sintered (e.g., fired) again, typically at a lower temperature than was used for the anode and electrolyte.

Multiple individual cells may be manufactured in this manner. These individual cells may then be stacked, i.e., placed one on top of the other, and interconnected together via an interconnect, such that the oxidant can only encounter the cathode, the fuel can only encounter the anode, and current can flow between cells. The interconnect may be made of a metal alloy, have electrical conductivity, and have flow channels mechanically imprinted to act as conduits for air and fuel. This method of interconnecting into a stack has led to relatively low energy densities, e.g., on the order of 1 kW/L.

There are various ways to increase the energy density of the fuel cell by creating monolithic stacks. A monolithic stack may also have cermet anode, cathode, and ceramic electrolyte layers. A fourth layer may be added to the cell, which may act as the interconnect.

As described by U.S. Pat. No. 4,816,036, a monolithic cell is a cell having substantially only these four active materials, without additional material for structural support. The '036 patent describes a method to create such a cell by mixing the four ceramic components individually into a plastic, and hot rolling the plastic into thin sheets. These sheets are then rolled into a multilayer tape and co-sintered (i.e., sintered at the same time, rather than in two stages at different temperatures) together.

There are at least two issues with this method, resulting from co-sintering. The first is that when sintered together, there may be a mismatch of coefficients of thermal expansion (CTE) between the four materials. For clarity, a match of CTE here means that the given materials have a CTE within a tolerable range, and a mismatch of CTE refers to when the given materials have a difference between their CTEs outside of the tolerable range, e.g., +/−10%.

This leads to formation of cracks that allow gas leakage between cells, reducing overall performance. Second, the sintering temperature cannot be optimized for each material independently, as all materials are sintered together at once. The high temperature required for creating dense electrolyte and interconnect layers may negatively affect the physical properties of the electrodes, most notably the cathode.

U.S. Pat. No. 8,715,886 B1 discloses a way to mitigate these issues by using a modified tape casting procedure. In this method, two porous layers made of the same ceramic as the electrolyte are separated by a dense layer. The dense layer acts as the electrolyte. The interconnect layer is then added to the other side of the porous layers. These four layers are repeated to create a porous scaffold of a monolithic stack. This stack is sintered together, followed by the impregnation of the porous layers with an electrode material.

This design may present several disadvantages. The flow path for both the oxidant and the fuel is only through the porous layers, restricting the flow of gas through the cell. Second, the infiltration of the porous layers with electrode material negatively impacts electrical conductivity due to the discontinuity of electrode depositions. Further, the layered construction is time consuming and expensive due to the multitude of steps required on each cell. Additionally, once in a stack, the individual flow paths must be sealed multiple times, one half cell layer at a time, without blocking the adjacent layer. The proposed porous layers are, generally, only 300-700 microns thick, and therefore this method is difficult, prone to error, and/or time consuming. Upon sealing, this method also adds a fifth material to the stack that introduces potential chemical compatibility issues, as well as thermal stresses caused by a mismatch in thermal expansion. As each cell must be created individually before the cells are stacked, there is a minimum thickness required so that the individual cells can be safely and practically handled. As such, there is a demand for a more efficient method of constructing high power density SOFCs that avoids or mitigates the aforementioned issues.

A high power density monolithic fuel cell stack, that may address the structural integrity, flow restriction, and electrical conductivity issues, such as those described previously, and a method of manufacturing same, are provided.

With reference to FIGS. 1 and 2, a solid oxide fuel cell stack 100 may include one or more solid oxide fuel cells 10. In an embodiment with two or more fuel cells in the stack, each fuel cell may be stacked one on top of the other.

Fuel cell 10 may comprise multiple layers, including an interconnect layer 1, an anode layer 90, an electrolyte layer 5, and a cathode layer 60.

For illustrative purposes and grammatical convenience, the fuel cell described herein is rectangular, though it is to be appreciated that the fuel cell can have any number of shapes. In the illustrated embodiment, fuel cell 10 has four sides 12a, 12b, 12c, and 12d. Side 12a opposes side 12c, side 12b opposes side 12d. These and similar terms are for grammatical convenience only, and it is to be appreciated that the invention would work in any number of orientations.

The electrolyte layer 5 is disposed between the cathode layer 60 and anode layer 90 of the fuel cell, defining a cathode-electrolyte-anode set of layers. In a stack with multiple fuel cells, there may be N electrolyte layers, where N is the number of fuel cells in the stack. In the illustrated embodiment, the anode layer is beneath the electrolyte layer, and the cathode layer is on top of the electrolyte layer. Alternatively, the anode layer may be above the electrolyte layer, and the cathode layer may be beneath the electrolyte layer. Each of the anode layer and the cathode layer may be referred to as an electrode layer. There will preferably be an equal number of anode layers and cathode layers, and, therefore, an even number of electrode layers. The anode walls and cathode walls, as applicable, may be referred to as electrode walls.

Interconnect layer 1 may be substantially planar, having a perimeter defined by the four sides 12a, 12b, 12c, and 12d. The interconnect layer will be disposed on both sides of each cathode-electrolyte-anode set of layers. In a stack with multiple fuel cells, there may be N+1 interconnect layers, where N is the number of fuel cells in the stack. In other words, if there is a single fuel cell, there will be a first interconnect layer on the top of the fuel cell, and a second interconnect layer on the bottom of the fuel cell. If there are two fuel cells, there will be a first interconnect layer on the top of the top fuel cell of the stack, and a second interconnect layer on the bottom of the bottom fuel cell of the stack, and a third interconnect layer between the two fuel cells. It is to be appreciated that any number of additional fuel cells could be added to the stack by adding an additional interconnect layer between each fuel cell. The interconnect layer may be impermeable to gas and/or electrically conductive.

Anode layer 90 may include a plurality of walls 4 and one or more anode flow channels 3 defined therebetween. Walls 4 may be elongate, extending from one side of the cell to the opposite side, e.g., from side 12a to side 12c. There may be a first wall 4 extending the length of side 12b, and a second wall 4 extending the length of side 12d. One or more channels 3 is defined between each pair of neighbouring walls 4, and the electrolyte layer and interconnect layer disposed above and below the anode layer. In addition to the outer walls 4 on sides 12b, 12d of the fuel cell, there may be any number of additional walls 4, for example, as illustrated, three additional walls 4, defining four anode flow channels 3. The anode flow channels 3 may have a coating of an anode material. Alternatively, the flow channels 3 may be substantially filled with the anode material.

Electrolyte layer 5 may be substantially planar, having a perimeter defined by the four sides 12a, 12b, 12c, and 12d. The electrolyte layer may be electrically insulating, ion conducting, and/or impermeable to gas.

Cathode layer 60 may include a plurality of walls 8 and one or more cathode flow channels 6 defined therebetween. Walls 8 may be elongate, extending from one side of the cell to the opposite side, e.g., from side 12b to side 12d. There may be a first wall 8 extending the length of side 12a, and a second wall 8 extending the length of side 12c. One or more channels 6 is defined between each pair of neighbouring walls 8, and the electrolyte layer and interconnect layer disposed above and below the cathode layer. In addition to the outer walls 8 on sides 12a, 12c of the fuel cell, there may be any number of additional walls 8, for example, as illustrated, three additional walls 8, defining four cathode flow channels 6. The cathode flow channels 6 may have a coating of a cathode material. Alternatively, the flow channels 6 may be substantially filled with the cathode material.

It will be appreciated that, in such a configuration, anode walls 4 extend in a first direction from side 12a to side 12c, and cathode walls 8 extend in a second direction perpendicular to the first direction, i.e., from side 12b to side 12d. The anode walls and cathode walls need not necessarily be arranged in a perpendicular fashion. Alternatively, for example, the anode walls and cathode walls could be arranged such that they extend in the same direction, or any other number of differing directions.

With reference to FIG. 23, a method 200 for manufacturing a fuel cell stack is provided. Method 200 includes depositing a first set of various materials, a first sintering to sinter the first set of materials and form a skeleton, disposing a second set of materials, and a second sintering to sinter the further materials to the skeleton. Optionally, a third set of materials may be disposed, and a third sintering may sinter the third set of materials to the skeleton.

Depositing may be implemented using a 3D printer of the environment, and/or manually using methods known in the art. Disposing may be implemented using a syringe or manually using methods known in the art. Sintering may be implemented using an oven or other means known in the art.

Method 200 may include depositing 202 an interconnect layer, for example, by depositing the interconnect material onto a work surface of the environment. Additional layers may be deposited separately, or, preferably, directly onto the previous layer deposited. The first interconnect layer deposited will be referred to as the bottom layer of the stack. The last interconnect deposited will be referred to as the top layer of the stack.

Method 200 may include depositing 204 a first electrode layer, e.g., walls of the first electrode layer. The electrode walls may be deposited directly onto the layer previously deposited. The first electrode layer will either be a cathode layer or an anode layer. The relative order of the cathode layer and the anode layer will not substantially affect the performance of the apparatus, but will generally alternate if there are multiple fuel cells in the stack.

Method 200 may include depositing 206 an electrolyte layer, i.e., by depositing the electrolyte material. The electrolyte layer may be deposited directly onto the layer previously deposited, thereby defining flow channels of the previously deposited first electrode layer.

Method 200 may include depositing 208 the walls of a second electrode layer. The second electrode layer will be a cathode layer if the first electrode layer is an anode layer; the second electrode layer will be an anode layer if the first electrode layer is a cathode layer. The second electrode layer may be deposited directly onto the layer previously deposited.

Method 200 may include depositing 210 a second interconnect layer. The second interconnect layer may be deposited directly onto the layer previously deposited, thereby defining the flow channels of the previously deposited second electrode layer.

Method 200 may include depositing 204 further first electrode layers, depositing 206 further electrolyte layers, depositing 208 further second electrode walls, and depositing 210 further second interconnect layers. This may be repeated until the desired number of layers is achieved.

Method 200 may include a first sintering 212 to sinter the materials deposited at this stage. The first sintering may be done at a first temperature selected according to the materials deposited at this stage. The temperature may be gradually increased, as described elsewhere herein.

Method 200 may include disposing 214 a first electrode material into the flow channels of the first electrode layer. The first electrode material may include either anode material or cathode material.

Method 200 may include a second sintering 216 to sinter the materials deposited at this stage. The second sintering may be done at a second temperature selected according to the materials deposited at this stage. The temperature may be gradually increased, as described elsewhere herein. The second temperature will generally be lower than the first temperature, as described elsewhere herein.

Method 200 may include disposing 218 a second electrode material into the flow channels of the second electrode layer. The second electrode material will include anode material if the first electrode material included cathode material; conversely, the second electrode material will include cathode material if the first electrode material included anode material.

Method 200 may include a third sintering 220 to sinter the materials deposited at this stage. The third sintering may be done at a third temperature selected according to the materials deposited at this stage. The temperature may be gradually increased, as described elsewhere herein. The third temperature will generally be lower than the second temperature, as described elsewhere herein.

Optionally, the third sintering 220 may be omitted, in an embodiment where the anode material and the cathode material can be safely sintered at substantially the same temperature. In this case, the depositing 218 of the second electrode material would take place prior to the second sintering 216. Optionally, the first sintering 212 may be omitted, in an embodiment where all of the materials can be sintered at substantially the same temperature. In such an embodiment, there would be a single sintering step after all materials that need to be sintered are deposited.

Optionally, after disposing 214, 218, either or both of the electrode materials, excess electrode material may be drained. In this manner, the flow channels may be coated with the electrode material, and a hollow space therein may be provided, which in use may act as an inlet for fuel and/or an outlet for exhaust. Alternatively, the flow channels may be substantially filled with electrode material. In such a case, in use, fuel may enter and exhaust may exit the channels by virtue of the inherent porosity of the sintered electrode material.

Optionally, the top interconnect layer and the bottom interconnect layer may be coupled, for example, using a wire. Optionally, the method may further include connecting the wire to an external electrical load.

Optionally, the method may include mixing a binding agent with an electrolyte ceramic powder to create the electrolyte material for use during depositing 206 the electrolyte layer. Optionally, the method may include mixing the binding agent (or a different binding agent) with an interconnect ceramic powder to create the interconnect material for depositing the interconnect layers.

Optionally, the method may further include depositing a manifold. Depositing the manifold may take place at the same time as one or more of depositing 202-210.

### EXAMPLES

A monolithic fuel cell stack may comprise one or more layers of individual fuel cells sintered together. Each fuel cell may be made of one or more, for example five, layers. A first layer may be an interconnect layer, which may include a thin sheet of an impermeable, electrically conductive interconnect material. A second layer may have one or more flow channels (which may be unidirectional) and/or one or more walls that may be lined with an active anode material. A third layer may include a thin sheet of an impermeable, electrically insulating, ion conducting electrolyte layer. A fourth layer may include a plurality of flow channels and walls lined with an active cathode material. Such flow channels and walls may extend in a direction substantially perpendicular to the channels in the second layer. The cathode material may be selected from a group of electrically conductive materials that catalyze the reduction of oxygen. For example, perovskites or a mixture of perovskites and the electrolyte material may be used. Further examples of such materials include lanthanum strontium manganite (LSM), LSM and yttria stabilized zirconia, lanthanum strontium cobalt ferrite (LSCF), or LSCF and gadolinium doped ceria.

A fifth layer may be an interconnect layer, which may substantially resemble the first layer. When stacking multiple cells together, the last layer of one cell may be shared, i.e., the same as, the first layer of an adjacent cell. In this way, each cell in the stack is electrically connected in series. Finally, the first layer of the first cell and the fifth layer of the last cell may be electrically connected through an external load, completing the circuit.

The walls in both the second and fourth layers of the fuel cell may be made of an electrolyte material, which enhances the structural integrity of the cell, and may enhance or extend a triple phase boundary (TPB). The triple phase boundary may be the intersection of the gas phase, electrolyte, and electrode. This may be the location where the majority of the reactions occur, so extending this boundary surface area may increase the power density of the cell.

The method of constructing such a stack may include depositing the interconnect layer, flow channel walls, and electrolyte, layer-by-layer. These layers may be repeated to create a fuel cell skeleton. The layer-by-layer deposition is commonly implemented using three-dimensional (3D) printing.

In use, fuel may be introduced on a first side of the stack into the anode flow channels (i.e., into anode inlets), which are bound on four sides by two walls, the interconnect layer and the electrolyte layer. Oxidant may be introduced on a second side of the stack adjacent to the first side into the cathode flow channels (i.e., into the cathode inlets), which are bound on four sides by two walls, the interconnect layer and the electrolyte layer. Oxygen ions, for example, may flow from the cathode layer to the anode layer through the electrolyte layer. Electrons may flow between the anode layer of one cell to the cathode layer of the adjacent cell through the interconnect layer. Electrons from the cathode of the last cell in the stack may flow through the electrical load or power source to the anode of the first cell in the stack. Exhaust gases may exit the channels on the sides opposite the inlets (i.e., via outlets), and may be vented into the atmosphere or otherwise removed.

The method may include mixing electrolyte and interconnect ceramic powders with a binding agent. Once deposited, heating the structure may remove the binding agent. This can be done at high temperatures selected specifically for the dense interconnect and electrolyte, thus avoiding the structural integrity issues arising from sintering the entire cell (i.e., including the electrode materials) at the same time. This may create fully ceramic electrolyte, interconnect, and flow channels, which makes up the fuel cell skeleton. Manufacturing the fuel cell skeleton with this method allows for tightly packed fuel cells and multiple open flow channels, which maximizes energy density.

An anode material may be deposited on all surface area of the anode flow channels. The anode material may then be sintered to the fuel cell skeleton at a temperature profile selected for the anode material.

A cathode material may be deposited on the flow channels that are aligned in a direction perpendicular to the anode channels, and then sintered to the fuel cell skeleton using its own sintering temperature profile. The dedicated flow channels for the anode and cathode reduce the restriction to gas flow. Depositing the electrode materials on the flow channels surface areas promotes electrical conductivity.

The individual stack, or multiple stacks, may be used to generate electricity from chemical fuels or be used to convert electrical energy into a chemical fuel. To generate electricity, fuel may be delivered to one side of the anode channels and oxidant to one side of the cathode channels. In use, the fuel and oxidant will flow through the channels where the half reactions occur. The exhaust gases may exit via the channels opposite to the inlets, and can be collected and removed.

Delivery and exhaust manifolds may be provided. The first and last interconnect layers may be electrically connected through an external load or power source, completing the circuit. To convert electrical energy into a fuel, the external load may be replaced with a power source and the flow of gases may be reversed. For example, water may be delivered to the cathode where it is split into hydrogen and oxygen. The hydrogen may be exhausted through the cathode outlet and the oxygen through the anode outlet. Instead of water, carbon dioxide, or another fuel precurser, may be delivered to the cathode flow channel inlets. The fuel precursor may be reduced to a fuel within the cathode flow channels, e.g., into hydrogen or carbon monoxide in the cases of water and carbon dioxide, respectively. The fuel may exit the flow channels on a side opposite the cathode inlet, and can be collected as an energy store or used as feedstock to create more complex fuels. Oxygen may be conducted from the cathode to the anode through the electrolyte, and exhausted through the anode outlet (opposite the anode inlet). To complete the circuit and/or obtain the energy required for oxidation, the top interconnect layer may be electrically connected to the bottom interconnect layer, e.g., via an electrical power source.

One embodiment may further include one or more external flow manifolds that may be deposited at substantially the same time as the fuel cell skeleton. These manifolds may provide channels to control the flow of fuel, oxidant, and exhaust gasses to and from the anode and cathode channel inlets and outlets. This embodiment provides an additional benefit of simplifying the seal and connection of multiple stacks together. In one embodiment, the manifold may include an external tubular shell around the fuel cell stack. The inner diameter of the tube may abut and/or intersect one or more of the edges of the fuel cell stack, which creates manifolds with one or more, as illustrated, four, flow channels, one on each side of the fuel cell stack. In use, the four manifold channels act as the fuel inlet, fuel outlet, oxidant inlet, and oxidant outlet. If the manifold may be deposited during the deposition of the fuel cell skeleton, they may be used to facilitate the deposition of the anode on the anode channel walls while maintaining separation from the cathode channels. Additionally, they may be used to deposit the cathode material in the cathode flow channels while maintaining separation from the anode channels, and vice versa.

A method for manufacturing a monolithic solid-oxide fuel cell stack is provided. The method may be implemented using a 3D printer. The 3D printer may, for example, use fused filament fabrication (FFF) technology, stereolithography (SLA) technology, or direct light processing (DLP) technology.

An electrolyte material may be used. The electrolyte material may include a ceramic powder. The electrolyte material may have certain properties. For example, once sintered, the electrolyte material may be: impermeable to gas, electrically insulting, and ion conducting. An example of such material may include yttria stabilized zirconia (YSZ), which exhibits oxygen ion conductivity at temperatures above 600° C.

The electrolyte material may be mixed with a binding agent to create an electrolyte-binder mix. The binding agent may be selected for the type of 3D printer being used. For example, in the case of FFF printing, the binding agent may be a thermoplastic. The thermoplastic may be melted and mixed with the electrolyte material. As this mixture is cooled, it may be extruded into a filament. For SLA and/or DLP printing, photosensitive resin may be used as the binding agent, which can be loaded with the electrolyte ceramic powder. The deposition of the given materials can be accomplished by curing of a material including photosensitive resin through light exposure, in an embodiment using SLA or DLP technology. Further, and alternatively, the deposition of the given materials may be accomplished by extruding a material including thermoplastic in an embodiment of the method using FFF technology.

In one embodiment, the electrolyte layer may be made of a material selected from a group of materials that exhibit ion conductivity. This group mainly consist of doped zirconia or ceria oxides. Dopants include yttria, scandia, ytterbium, erbium, gadolinium, dysprosium, calcium, and samarium. Alternatively, the electrolyte material can be made of perovskites or brownmillerite such as lanthanum gallate or lanthanum titanate, as well as doped perovskites such as strontium doped lanthanum gallate.

An interconnect material may be used to create the interconnect layer. The interconnect material may have certain properties, for example, the interconnect material may be electrically conductive, impermeable to gas, and have low ionic conductivity. Further, and specific to monolithic designs, this interconnect material may be able to be sintered to the electrolyte. This may be accomplished by selecting a material that has an overlapping sintering window with that of the electrolyte. That is, there may be a common sintering temperature that is high enough that both the electrolyte and interconnect will achieve reasonable density, e.g., 90% or greater density, but low enough to avoid any adverse effects, such as morphology changes. Further, ideally, the materials would have compatible coefficients of thermal expansion (CTE), e.g., within a range of +/−10%. An example of possible interconnect materials may include doped-lanthanum chromite, with the most common dopants being strontium (lanthanum, strontium, chromite (LSC)) and calcium. Both dopants offer a compatible CTE and high electrical conductivity. Alternatively, perovskites with a titanate base may be used, such as strontium doped lanthanum titanate. A second solution may be created with a mixture of the interconnect powder and the same binder as the electrolyte to create an interconnect-binder mix.

With reference to FIGS. 1-3, a fuel cell stack may include one or more interconnect layers 1. For appropriate sealing and electrical connection of the final stack, the first layer (interconnect layer) may be made of a material including the interconnect material, e.g., the interconnect-binder mix. This may be a continuous layer that spans all flow channels to act as both the barrier for gas separation, and an electrical connection between adjacent cells. The thickness of this layer may be in the order of 10-500 microns. The interconnect layer may be printed using a 3D printer using the interconnect-binder mix as a filament. As illustrated, the interconnect layer (and, e.g., other layers) may be substantially rectangular and planar. The next layer may be printed using the electrolyte-binder mix.

In FFF printing, the change in material from the electrolyte-binder mix to the interconnect-binder mix may be achieved by splicing the interconnect filament and the electrolyte filament together. The length requirements of the filaments being spliced are such that when the first layer may be finished, the first filament may be consumed, and the second filament may be extruded. This may also be achieved by using a FFF printer with dual extruders, for example, the interconnect filament may be extruded by a first extruder of the dual extruders, and the electrolyte filament may be extruded by a second extruder of the dual extruders. In DLP or SLA printing, the two different liquid slurries may be contained in separate vats.

In one embodiment, the interconnect material may be deposited out of a vat containing the interconnect-binder mix, and the other layers may be deposited out of a vat containing the electrolyte-binder mix. This second layer may be formed by deposition of a plurality of support walls 2, as illustrated in FIGS. 1-2. Each support wall may be substantially elongate, extending from one side of the layer to an opposite side. There may be a gap defined between the support walls that will become the flow channels 3 for fuel, as shown in FIGS. 1-2.

Printing dedicated flow channels may be advantageous compared to methods implementing tape casting or freeze casting, because the instant method provides a lower resistance to gas flow than does relying on flow through a porous material. Further, the walls may be deposited such that there may be one more wall 4 than flow channels as illustrated in FIGS. 1-3. That is, support walls may be provided at both edges, to serve as a seal, separating the flow of oxidant and fuel, which may ultimately flow in a crossflow configuration. This important design characteristic avoids the costly, time consuming, and difficult requirement of sealing hundreds or thousands of individual submillimeter layers as described in the prior art. It also avoids the need to add an additional sealing material that can cause material compatibility issues from mismatched CTE, or the diffusion or vaporization of species out of the seal and into the cathode or anode. For example, the poisoning of cathodes by silicon that may be present in the sealing material.

The interior channel walls (i.e., the channel walls that have flow channels therebetween) serve the dual purpose of supporting the interconnect and electrolyte layers and acting as a conduit for oxygen ions.

One or more of the interior channel walls may be coated with active anode material. Once coated with active anode material, the walls may act as an extension of the electrolyte and therefore increase the triple boundary layer due to ion conductivity. It is to be appreciated that the triple boundary layer includes an area where electrolyte material and electrode material are sintered together.

In another embodiment, the walls, or a portion of the walls, may be created out of the interconnect material, which may reduce resistance to the flow of electrons between the triple boundary layer to/from the interconnect, and ultimately to/from the adjacent cell. The layer height, wall thickness, and channel thickness can be selected according to application and limitations of the manufacturing machines being used. The layer height, wall width, and channel width may be in the range of 25 microns to 5 mm (including, for example, a range of 25 microns to 2 mm, and/or 25 microns to 1 mm), but are not necessarily equal.

After depositing the anode flow channel layer, an electrolyte layer 5 may be deposited. Like the interconnect, this may be a continuous sheet that separates the fuel on the anode side and oxidant on the cathode side. This layer may be generally in the order of 10-500 microns thick. This layer may be deposited out of the electrolyte material so that it conducts ions and not electrons. This top layer also completes the flow channels such that there are three sides of electrolyte, one edge of interconnect material, and two sides open for the inlet and outlet of fuel. In another embodiment, this top layer also completes the flow channels such that there are three sides of interconnect, one edge of electrolyte material, and two sides open for the inlet and outlet of fuel. In yet another embodiment, the flow channel walls (whether of an anode layer or a cathode layer) may be made of the electrolyte material for a portion, e.g., a portion proximate the electrolyte layer, and may further include the interconnect material for some or all of the remainder, e.g., a portion proximate the interconnect layer.

After the electrolyte layer, there may be another layer of flow channels 6 and support walls 7. This layer may include the cathode flow channels 6 that may run in a perpendicular direction to the anode flow channels 3. The walls defining the cathode flow channels may be coated and/or filled with the cathode material. There may be one more wall 8 than flow channels, forming a barrier and/or seal on both edges of the cathode flow path. The interior walls may act as support, creating a grid pattern that reinforces the electrolyte and interconnect layers. Anode walls pass in a first direction below the electrolyte and above the interconnect, while the cathode walls cross in a second direction (perpendicular to the first direction) on the adjacent side of each layer. Like the anode flow channel walls, the cathode flow channel walls may be made of, for example, the electrolyte material so that they are also ion conducting, and act to increase the triple boundary layer or, further or alternatively, the interconnect material, which may increase the electrical conductivity between cells or some portion of both materials to balance the benefits.

The cathode layer may be followed by an additional interconnect layer, which may be part of the base fuel cell unit. For a stack of multiple fuel cells, the top interconnect layer of the first cell may also serve as the bottom interconnect layer of the adjacent cell. Therefore, each additional cell would only require four layers, anode channels, electrolyte, cathode channels, and interconnect. The method to deposit these layers may be repeated until the desired number of cells is created.

An example design has equal dimensions of 400 microns for the layer length, wall width, and channel width. In such an embodiment, each of the interconnect and electrolyte layers may have a thickness of 90-110 microns, e.g., 100 microns. In testing, this would provide sufficient surface area to produce an energy density of 6 kW/L using an energy flux of 0.4 W/cm². These high energy densities are achievable because each layer may be stacked and sintered directly together. Further, they are all printed at the same time, allowing one layer to act as a support for the adjoining layers. This creates the opportunity for sheet and wall widths thinner than would be possible to manufacture individually.

The relative order of the anode and cathode layers can be swapped without affecting the performance of the cell. The anode material may be selected from a group of electrically conductive materials that catalyze the oxidation of hydrocarbon fuels. For example, the anode material may include nickel oxide, or a mixture of nickel oxide and the electrolyte material. Further examples of anode materials include nickel oxide and yttria stabilized zirconia, and/or nickel oxide and gadolinium doped ceria. Alternatively, perovskite oxides can be used. For example, doped lanthanum chromite, as in lanthanum, strontium, chromium, and/or manganite. The cathode material may be selected from a group of electrically conductive materials that catalyze the reduction of oxygen. For example, such a material may include perovskites, or a mixture of perovskites and the electrolyte material. Some examples include lanthanum strontium manganite (LSM), LSM and yttria stabilized zirconia, lanthanum strontium cobalt ferrite (LSCF), and/or LSCF and gadolinium doped ceria.

Upon completion of 3D printing, the stack may include a binder and ceramic material. The stack may then be heated, which may substantially remove the binder material. The stack may be heated (i.e., sintered) in two stages. First, the stack may be heated to a temperature of 150-300° C. to begin the process of incinerating the binder from the ceramic material. After being held at this temperature for, for example, one to two hours, the temperature may be increased, for example, by 10-50° C. per hour up to 400-700° C. Once the cell reaches these elevated temperatures, the binder will be completely incinerated, and the temperature can be rapidly increased by 100-300° C. per hour to sinter the remaining ceramic powders. The removal of the binder in this manner is referred to as de-binding.

During the first sinter, the anode and cathode materials are not yet present, so the sintering temperatures can be selected according to the materials used for the electrolyte and interconnect layers. For context, this may be temperatures as high as 1350-1800° C. if using YSZ and LSC. Once sintered, the ceramic skeleton will be made into a fuel cell stack by adding the cathode and anode layers. Starting, e.g., with the anode 9, this may be achieved by mixing a slurry of an active anode powder, a binder, and a solvent. An example anode material is nickel oxide. The anode powder may also be mixed with electrolyte powder for mixed ionic and electric conductivity. This slurry may be disposed (e.g., injected) into the anode channels such that either all sides of the flow channel are coated, or the channels are filled. Excess anode slurry may be removed from the external surfaces such that the anode of one cell is not in direct contact with the anode of the adjacent cell. The solvent may be dried before the entire structure is heated again to burn away the binder and sinter the anode material to the channel walls. This firing cycle may be done at an intermediate temperature, e.g., between 1300-1400° C. The de-binding and sintering may shrink the anode material so that the remaining anode material is not completely filling the channel but should be sufficiently thick, e.g., 5 microns thick, with a bore or hollow space defined therein. The existence of anode material on the entire perimeter of the anode flow channel ensures a continuous electrical connection between the electrolyte, active anode material, and the interconnect. The open space in the centre of the flow channel allows for increased gas flow through the channel with less resistance than if it were flowing through the anode porosity alone.

This method may then be repeated with a cathode material 10, and may be used to coat (e.g., injected into) the cathode flow channels 7, as illustrated in FIGS. 1-3. An example of a suitable cathode material may include, without limitation, lanthanum strontium manganite (LSM). LSM, LSC, and YSZ materials portend good compatibility at the cell operational temperatures. The LSM powder could also be mixed with YSZ powder for mix conductivity. It may be possible to use YSZ and lanthanum strontium cobalt ferrite (LSFC) or another combination of materials that do not display optimal compatibility. In this case however, a boundary coating may be applied to the flow channel before electrode material is applied thereto. In this case, the active cathode material would be deposited last. Similar to the anode, any excess cathode slurry may be removed from the external surfaces such that the cathode of one cell is not in direct contact with the cathode of the adjacent cell. Once the cathode channels are coated with the cathode material, they will be dried and sintered, however this time at a temperature profile optimized for the cathode material. The temperatures required at this stage may be further reduced to, for example, approximately 1,150-1,250° C., which may avoid diffusion and chromium poisoning of the cathode, and the other morphology issues, including for example those as described elsewhere herein.

Thermal stress and residual thermal strain are both reduced by building the support structure out of electrolyte and interconnect, and sintering prior to the addition of the anode and cathode layers. The CTE of the interconnect and the electrolyte material should be matched as near to identical as possible, or at least within a tolerable range, e.g., +/−10%, although the temperature required for the interconnect can be higher without hindering effectiveness. Generally, a difference in CTE will be tolerable if cracks are avoided during the manufacture and/or use of the apparatus.

The layers of the fuel cell skeleton are preferably free of any cracks, so that they maintain a substantially gas-tight seal between layers. Because the majority of the stack may be made of the electrolyte material, the properties of the electrolyte material drives the degree of expansion and contraction of the cell when heated and cooled. The high ratio of electrolyte material minimizes the strain on the electrolyte caused from the disproportional expansion or contraction of other layers. If the interconnect material has a sufficient CTE match with the electrolyte material, it may also be relatively strain-free. If the interconnect material has a higher CTE than the electrolyte material, the interconnect material may be held in compression, therefore avoiding a tensile load, which may be more likely to create cracks. The relatively low volume of anode and cathode material reduces the stress applied to the electrolyte and interconnect caused by any CTE mismatches beyond the tolerable range. This may cause a relatively high strain on the electrodes, if their CTE cannot be sufficiently matched. Small variations in CTE are tolerable because the formation of cracks in the electrodes will not substantially affect the performance of the cell. Large mismatches may result in the loss of adhesion of the electrodes to the electrolyte or interconnect, reducing or destroying the effectiveness of the cell.

The individual stack, or multiple stacks, could be used to generate electricity from chemical fuels or be used to convert electrical energy into a chemical fuel. To accomplish this, fuel may be delivered to one side of the anode channels and oxidant to one side of the cathode channels. The fuel and oxidant flow through the channels where the half reactions occur. The exhaust gases exit the channels opposite to the inlets and may be collected and removed. The first and last interconnect layers may be electrically connected through an external load or power source, completing the circuit.

One way to connect the stack to an external load may be to mechanically connect or solder a wire to the last interconnect layer 11 as shown in FIG. 4. This wire may also be connected to one side of an external load 12. The circuit may be completed by connecting a wire from the other side of the external load to the first interconnect layer 13. In use, one side of an electrical load may be connected to the bottom interconnect layer of the bottom cell and the other side of the electrical load to the top interconnect layer of the top cell, such that current flows through the fuel cells in series and then through the electrical load. Alternatively, one side of an electrical power source may be connected to the bottom interconnect layer of the bottom cell and the other side of the electrical power source may be connected to the top interconnect layer of the top cell, such that current flows through the power source and then through the fuel cells in series.

In one embodiment, the monolithic stack may be coupled to, or further include, a shell (e.g., a monolithic planar tube). In use, the tubular shell may control the flow of fuel, oxidant, and exhaust gasses to and from the stack. The tubular shell may be printed at the same time as the fuel cell skeleton. This may provide advantages, for example, a reduction or elimination of the requirement to add the external manifold to the stack, and may facilitate the deposition of anode and cathode materials to the fuel cell skeleton by providing isolated flow paths. To accomplish this, it may be made of a material that can be sintered at the same temperature(s) as the electrolyte and the interconnect. Optionally, the shell may be made of one or both of the electrolyte and interconnect materials. When each layer of the fuel cell is deposited, a portion of the shell may also be deposited out of the same material as that layer.

Once encased in the tubular shell, many such monolithic-planar-tubes can be connected to reach the desired total power output. The result would bear resemblance to a shell and tube type heat exchanger.

The monolithic fuel cell stack 14, e.g., as shown in in FIGS. 5 and 6, may be surrounded by an outer tubular shell 15. The inner diameter may be sized such that it intersects the edges of the monolithic stack 16, creating flow channels 17, 18, 19, 20. Put another way, flow channels 17, 18, 19, 20 each may be defined between a side of the fuel cell stack and an inner surface of the shell 15. In use, fuel may enter the tube through a hole, which may be along the side shell or at one of its ends. The embodiment illustrated in FIGS. 7-11 shows holes 21 on the top of the tube. In this embodiment, each tubular shell has a lid extending from the sides of the fuel cell stack to the inner edge of the shell, and the hole 21 is disposed in the lid. The fuel can flow down the length of the given flow channel, e.g., flow channel 17, but cannot flow into the adjacent flow channels 19, 20 because the intersection of the outer edge of the stack is (in the illustrated embodiment) adhered to the inner edge of the tube. The fuel may be forced to flow through the fuel cell stack towards the outer flow channel 18 on the opposite side. The reactant products and any unspent fuel exits the cell into the outer flow channel 18, and may be exhausted out a hole 22 in flow channel 18.

Similarly, oxidant may enter the tube via one of the flow channels adjacent to the fuel flow channel 19. The example illustrated has an entry hole 23 on the side of the tube partway (e.g., approximately a third of the way) from the base of the tube, although this hole can be disposed at any point along the tube. In use, the oxidant may be forced to flow through the fuel cell stack to the external flow channel on the opposite side 20. The unreacted oxidant exits the tube through a hole 24 on the side of the tube partway (e.g., two thirds of the way) from the base of the tube.

The inlets and outlets (as illustrated, there may be one or more of each) to the tube may be strategically placed to control the segregation of fluids. In the illustrated embodiment, the tubes may be sealed against the outside edges of the shell 25 such that the oxidant may be contained inside the shell. The fuel inlet and exhaust are connected to the shell at each of the ends of the shell. Current flows from cell to cell through the fuel cell stack, down the length of the tube. The first and last interconnect layers 26 may protrude out of the tube at each end so they can be connected to the external load. Inside the shell, there may be a divider 27 separating the inlet and outlets for the oxidant.

The examples and corresponding figures used herein are for illustrative purposes. Different configurations and terminology can be used without departing from the principles expressed herein.

Although the invention has been described with reference to certain specific embodiments, various potential modifications thereof will be apparent to those skilled in the art without departing from the scope of the invention. For example, some such modifications and further embodiments may include, but are not limited to:
(a) A SOFC where both the active cathode and anode material may be the same, or have substantially the same, preferred sintering profile. In this case, the electrodes can be deposited on the cathode and anode channels at the same time and sintered together. Alternatively, if one of the electrodes has the same preferred sintering temperature as the electrolyte and interconnect, it could be deposited before sintering of the base structure, and all three layers could be sintered together.
(b) There are variations on the external flow channels besides the tubular shell going lengthwise along the direction of current. The outer shell may not only be cylindrical but could be polygonal, for instance the octagon in FIG. 12. There could also be separated walls as in the rectangular flow channel for each side of the fuel cell stack as in FIG. 13. A third possible variation may be having two crossing tubes 30 going along the direction of flow for the fuel and the oxidant, with the fuel cell stack at the centre of the crossing tubes as depicted in FIG. 14.
(c) The flow channel and wall may be configured with continuous walls perpendicular to each other. Alternatively, the interior walls may not extend the full length of the cells as depicted in FIG. 15. Further, and in the alternative, the fuel and oxidant flow may have a tortuous path from inlet to outlet. An option for this is the serpentine flow depicted in FIGS. 16-18.
(d) The fuel cell skeleton may have flanges deposited at one or more corners, for example, at each of the four corners of the fuel cell stack, during the deposition of the electrolyte and interconnect layers. These flanges may facilitate the sealing of the fuel cell stack to an external manifold, in operation and/or during the deposition of the anode and cathode layers. Some examples of flanges 21 are depicted in FIGS. 19 and 20.
(e) With reference to FIGS. 21 and 22, a second manifold 28 may be provided, configured to deliver fuel and/or oxidant to the fuel cells via the shells, and/or to permit exhaust of gases, via the inlet and outlet holes, as applicable, of shells 25. These monolithic planar tubes may be encased in a pressurized vessel. Pressurizing the vessel may reduce the likelihood of cracks forming during use.

The scope of the claims is not be limited by the illustrative embodiments set forth in the examples, but should be given the broadest interpretation consistent with the description herein.

### CLAUSES

Clause 1. A fuel cell stack apparatus, comprising: a fuel cell, having a first interconnect layer including an interconnect material, an anode layer including an anode material, an electrolyte layer including an electrolyte material, a cathode layer including a cathode material, and a second interconnect layer including the interconnect material; the electrolyte layer being positioned between the anode layer and the cathode layer, the electrolyte layer including an electrolyte material; and the anode layer, the electrolyte layer, and the cathode layer being positioned between the first interconnect layer and the second interconnect layer.
Clause 2. The apparatus of any one or more of clauses 1-19, further comprising: a second fuel cell, wherein a first interconnect layer of the second fuel cell comprises the second interconnect layer of the fuel cell.
Clause 3. The apparatus of any one or more of clauses 1-19, wherein: the anode layer further comprises a plurality of anode walls with anode channels defined therebetween, the anode channels having the anode material therein; and the cathode layer comprises a plurality of cathode walls with cathode channels defined therebetween, the cathode channels having the cathode material therein.
Clause 4. The apparatus of any one or more of clauses 1-19, wherein the anode walls extend in a first direction, and the cathode walls extend in a second direction substantially perpendicular to the first direction.
Clause 5. The apparatus of any one or more of clauses 1-19, further comprising an electrical connection between a second interconnect layer of the second fuel cell and the first interconnect layer of the fuel cell.
Clause 6. The apparatus of any one or more of clauses 1-19, further comprising a manifold configured to deliver fuel to an inlet of the anode layer; deliver oxidant to an inlet of the cathode layer; exhaust excess fuel from an outlet of the anode layer; and exhaust waste gases via an outlet of the cathode layer.
Clause 7. The apparatus of any one or more of clauses 1-19, further comprising a shell disposed around a perimeter of the stack and intersection corners of the layers of the stack.
Clause 8. The apparatus of any one or more of clauses 1-19, further comprising a fuel inlet in the shell and an exhaust outlet in the shell.
Clause 9. The apparatus of any one or more of clauses 1-19, further comprising an external vessel disposed about the shell.
Clause 10. The apparatus of any one or more of clauses 1-19, wherein the external vessel is pressurized.
Clause 11. The apparatus of any one or more of clauses 1-19, wherein the anode walls and cathode walls include the electrolyte material.
Clause 12. The apparatus of any one or more of clauses 1-19, wherein the anode walls and cathode walls include the interconnect material.
Clause 13. A method for manufacturing a fuel cell stack, comprising: depositing a first interconnect layer; depositing a first electrode layer; depositing an electrolyte layer; depositing a second electrode layer; depositing a second interconnect layer; and sintering at a first temperature.
Clause 14. The method of any one or more of clauses 1-19, further comprising: disposing an anode material into the first electrode layer; and disposing a cathode material into the second electrode layer.
Clause 15. The method of any one or more of clauses 1-19, further comprising: sintering, at a second temperature lower than the first temperature, prior to disposing the cathode material.
Clause 16. The method of any one or more of clauses 1-19, further comprising: sintering, at a third temperature lower than the second temperature, after disposing the cathode material.
Clause 17. The method of any one or more of clauses 1-19, further comprising sintering at a second temperature lower than the first temperature after disposing the cathode material.
Clause 18. The method of any one or more of clauses 1-19, further comprising: electrically connecting an upper interconnect layer of the stack to a bottom interconnect layer of the stack.
Clause 19. The method of any one or more of clauses 1-19, further comprising: repeating the depositing of interconnect, electrode, and electrolyte layers until a fuel cell skeleton corresponding to a desire number of fuel cells is achieved.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A fuel cell stack apparatus, comprising:
a fuel cell, having a first interconnect layer including an interconnect material, an anode layer including an anode material, an electrolyte layer including an electrolyte material, a cathode layer including a cathode material, and a second interconnect layer including the interconnect material;
the electrolyte layer being positioned between the anode layer and the cathode layer, the electrolyte layer including an electrolyte material; and
the anode layer, the electrolyte layer, and the cathode layer being positioned between the first interconnect layer and the second interconnect layer.

2. The apparatus of claim 1, further comprising:
a second fuel cell, wherein a first interconnect layer of the second fuel cell comprises the second interconnect layer of the fuel cell.

3. The apparatus of claim 1, wherein:
the anode layer further comprises a plurality of anode walls with anode channels defined therebetween, the anode channels having the anode material therein; and
the cathode layer comprises a plurality of cathode walls with cathode channels defined therebetween, the cathode channels having the cathode material therein.

4. The apparatus of claim 3, wherein the anode walls extend in a first direction, and the cathode walls extend in a second direction substantially perpendicular to the first direction.

5. The apparatus of claim 2, further comprising an electrical connection between a second interconnect layer of the second fuel cell and the first interconnect layer of the fuel cell.

6. The apparatus of claim 1, further comprising a manifold configured to
deliver fuel to an inlet of the anode layer;
deliver oxidant to an inlet of the cathode layer;
exhaust excess fuel from an outlet of the anode layer; and
exhaust waste gases via an outlet of the cathode layer.

7. The apparatus of claim 1, further comprising a shell disposed around a perimeter of the stack and intersection corners of the layers of the stack.

8. The apparatus of claim 7, further comprising a fuel inlet in the shell and an exhaust outlet in the shell.

9. The apparatus of claim 7, further comprising an external vessel disposed about the shell.

10. The apparatus of claim 9, wherein the external vessel is pressurized.

11. The apparatus of claim 3, wherein the anode walls and cathode walls include the electrolyte material.

12. The apparatus of claim 3, wherein the anode walls and cathode walls include the interconnect material.

13. A method for manufacturing a fuel cell stack, comprising:
depositing a first interconnect layer;
depositing a first electrode layer;
depositing an electrolyte layer;
depositing a second electrode layer;
depositing a second interconnect layer; and
sintering at a first temperature.

14. The method of claim 13, further comprising:
disposing an anode material into the first electrode layer; and
disposing a cathode material into the second electrode layer.

15. The method of claim 14, further comprising:
sintering, at a second temperature lower than the first temperature, prior to disposing the cathode material.

16. The method of claim 15, further comprising:
sintering, at a third temperature lower than the second temperature, after disposing the cathode material.

17. The method of claim 14, further comprising sintering at a second temperature lower than the first temperature after disposing the cathode material.

18. The method of claim 14, further comprising:
electrically connecting an upper interconnect layer of the stack to a bottom interconnect layer of the stack.

19. The method of claim 14, further comprising:
repeating the depositing of interconnect, electrode, and electrolyte layers until a fuel cell skeleton corresponding to a desire number of fuel cells is achieved.
